(19) United States
(12) Patent Application Publication
(10) Pub. No.: US 2006/0001509 A1
(43) Pub. Date: Jan. 5, 2006

(54) Systems and methods for automated resonant circuit tuning

(76) Inventor: Phillip R. Gibbs, Atlanta, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/168,296

(22) Filed: Jun. 29, 2005

Related U.S. Application Data
(60) Provisional application No. 60/584,233, filed on Jun. 30, 2004.

(51) Int. Cl. H01P 1/20

(52) U.S. Cl. 333/202; 333/186; 424/9.1; 702/85; 73/1.01

(57) ABSTRACT

An apparatus and method for automatically tuning a resonant circuit in a chiroptical measurement system. A sample cell holds a sample being measured for a chiroptical property as the sample is modulated by the resonant circuit. A signal source coupled to the resonant circuit generates a driving signal at one of a plurality of frequencies to modulate the resonant circuit. The frequencies are within a range of expected resonant frequencies for the resonant circuit. A feedback loop circuit coupled to the signal source is used to adjust the frequency of the driving signal to another of the frequencies in response to a feedback signal associated with a measured parameter of the driving signal. In this way, the frequency of the driving signal is adjusted to create a resonant condition. The driving signal may also be applied at a reduced power level so that the resonant circuit can be driven at off-resonant frequencies within the range of frequencies.

### RELATED APPLICATIONS

The present application hereby claims the benefit of U.S. Provisional Patent Application Ser. No. 60/584,233, which was previously filed by the same inventors on Jun. 30, 2004.

### FIELD OF THE INVENTION

This invention relates to systems for resonant circuit tuning and, more particularly, to systems and methods for automated resonant circuit tuning in a chiroptical measurement system.

### BACKGROUND OF THE INVENTION

In general, a “chiral” object is one that is not superimposable upon its mirror image. In other words, a chiral object and its mirror image are similar in constitution or content, but different in orientation. Examples of chiral objects include a human hand, a mechanical screw, or a propeller. While the mirror images look similar, they have different characteristic orientations with regard to their parts (e.g., the digits on the hand, the helical orientation of the screw, and the pitch orientation of the blades on the propeller).

In stereochemistry, two forms of a chiral object (such as a molecule) are also known as enantiomers, which is a type of stereoisomer. Enantiomers have the same chemical purity (e.g., the same mass, absorbance, refractive index, Verdet constant, etc.) but have different configurations in symmetry or symmetric properties. A collection containing only one enantiomeric form of a chiral molecule is often the same chemical purity (e.g., the same mass, absorbance, refractive index, Verdet constant, etc.) but have different configurations in symmetry or symmetric properties. A collection containing only one enantiomeric form of a chiral molecule is often referred to as enantiopure, enantiomerically pure, or optically pure. However, unlike other stereoisomers, enantiomers are often difficult to separate and quantitate.

Detection of chiral molecules has become of increasing interest to the pharmaceutical industry over the last twenty years. This interest is driven at least in part by the common occurrence of drastically different pharmacological activities between enantiomers. The different pharmacological activity associated between enantiomers often requires that the approved version of the drug be produced as a single chiral isomer. This single chiral isomer would be selected as it would have the most beneficial effects or, in some cases, would not have dangerous pharmacological activity. However, analytical methods for assaying enantiomeric purity have not kept pace with the increasing demands for rapid, high sensitivity, enantiomeric analysis.

Currently, chiral separation of enantiomers and individual quantification of chiral species is a commonly used technique for assaying enantiomeric purity. A direct non-contact method of assaying enantiomeric purity would be preferred and increased sensitivity over the ˜99.5% enantiomeric excess (ee) limit is needed. Several optical properties unique to chiral molecules have been utilized in techniques such as polarimetry, optical rotatory dispersion, and circular dichroism. However, known quantification techniques utilizing such optical properties lack the sensitivity to detect pharmacologically relevant levels of enantiomeric impurities in many desired modern pharmaceuticals.

Within analytical instrumentation that detects pharmacologically relevant levels of enantiomeric impurities, resonant circuits are commonly employed as filters. Resonance in a circuit occurs when the reactance of an inductor balances the reactance of a capacitor at some given frequency. In such a resonant circuit where it is in series resonance, the current will be maximum and offering minimum impedance. In parallel resonant circuits the opposite is true. As shown in FIGS. 1A and 1B, both series and parallel resonant circuits may be utilized depending on whether the system designer desires minimum impedance (series) or maximum impedance (parallel) at the resonant frequency for optimum system operation.

One such application of a resonant circuit is in the AC modulation of samples in a magneto-optical measurement (Turvey, K. Rev. Sci. Instrum. 64 (6), June 1993, pp 1561-1568). Since the modulation is dependent only on the applied magnetic field to the sample, it is desirable to maximize the signal by maximizing the applied field. If modulated signal recovery techniques, such as lock-in detectors or lock-in amplifiers, are used to recovery the signal, it would be desirable to have only a single frequency modulate the system with all other modulations being suppressed. In addition, it would be desirable to minimize the amplifier power requirements needed to drive the system or equivalently maximize the utilization of an available amplifier. Therefore, setting up the modulation coil associated with the sample cell to be a resonant circuit accomplishes both these tasks.

However, the “tuning” aspect of resonant circuits is plagued with issues related to component tolerances and drift due to environmental conditions as well as aging components. In such a situation, the resonant circuit may be designed for optimum power transfer and efficient resonant operation, but be implemented with a less than ideal circuit. For example, the component tolerances may accumulate to yield a less than desirable resonant performance of the circuit during operation. Further, the resonant performance of the circuit may drift over time due to the aggregate aging of various circuit components. In systems that detect chiroptical properties of a sample exposed to modulation stimulation, the loss of resonant circuit efficiency may lead to an undesirable decrease in detection sensitivity.

Thus, there is a need for an improved system and method for maintaining resonant circuit performance, and in particular, for maintaining optimal resonant circuit tuning performance when detecting chiroptical properties of a sample exposed to modulated stimulation.

### SUMMARY OF THE INVENTION

In accordance with the invention, a system and method are disclosed to yield more sensitive detection of a chiral property of a sample by utilizing an active tuning technique for one or more resonant circuits. Generally, the invention automatically tunes a resonant circuit in a chiroptical measurement system without the need for human or manual intervention to accommodate for variations in component tolerances and component drift.

According to one aspect of the present invention, a method is described for automated tuning of a resonant circuit when detecting a chiral property of a sample. The method begins by populating a data structure with a plurality of frequencies. The plurality of frequencies may be pre-determined within an expected range of frequencies for the resonant circuit. A driving signal is then generated using one of the plurality of frequencies in the data structure. Next, the method applies the driving signal to the resonant circuit while detecting a chiral property of the sample, such as the Verdet constant, based at least in part upon the one of the plurality of frequencies in the data structure. A feedback signal is then measured, where the feedback signal is associated with a parameter (e.g., current) of the driving signal. Finally, the driving signal is adjusted to use another one of the plurality of frequencies in the data structure in response to the feedback signal. In this way, a resonant condition with the resonant circuit may be created.

In another aspect of the invention, another method is described for automated tuning of a resonant circuit when detecting a chiral property of a sample. The method begins by applying a driving signal to the resonant circuit, where the driving signal has a driving frequency within a range of frequencies. A resonance parameter of the driving signal is monitored as part of a feedback loop to produce a feedback signal. Thereafter, the frequency of the driving signal is adjusted according to the monitored resonance parameter where the adjusted frequency of the driving signal modulating a probe beam of light used for detecting the chiral property of the sample.

In yet another aspect of the invention, an apparatus is described for automated tuning of a resonant circuit when detecting a chiral property of a sample. In this aspect, the apparatus includes a sample cell, a signal source, and a feedback loop. The sample cell holds the sample and is modulated by the resonant circuit. The signal source is coupled to the resonant circuit and can provide a driving signal at one of a plurality of frequencies to modulate the resonant circuit. These frequencies are within a range of expected resonant frequencies for the resonant circuit. The feedback loop circuit is coupled to the signal source and operative to adjust the one of the plurality of frequencies of the driving signal to another of the plurality of frequencies in response to a feedback signal, which is associated with a measured parameter (e.g., current, power, rms voltage, etc.) of the driving signal.

In still another aspect of the invention, another apparatus is described for automated tuning of a resonant circuit. The apparatus includes a light source, a sample cell, a modulation source, a monitoring circuit, and a feedback circuit. The light source generates a probe beam of light applied to the sample cell. The sample cell holds the sample and a solvent for the sample as the probe beam of light is exposed to the sample. The probe beam of light is modulated by the resonant circuit. Driving the resonant circuit is the modulation source, which applies a driving signal at one of a plurality of frequencies within a range of expected resonant frequencies for the resonant circuit. The monitoring circuit monitors a measured parameter (e.g., current, rms voltage, power, etc.) of the driving signal as the driving signal is applied to the resonant circuit. Finally, the feedback circuit adjusts the one of the plurality of frequencies of the driving signal to another of the plurality of frequencies in response to a feedback signal, which is associated with the measured parameter of the driving signal.

It is to be understood that both the foregoing general description and the following detailed description are exemplary and explanatory only and are not restrictive of the invention, as claimed. Advantages of aspects of the invention may be set forth in part in the description which follows, and in part will be obvious to one skilled in the art from the description, or may be learned by practice of embodiments of the invention.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a diagram of known resonant circuits configured in series and parallel.

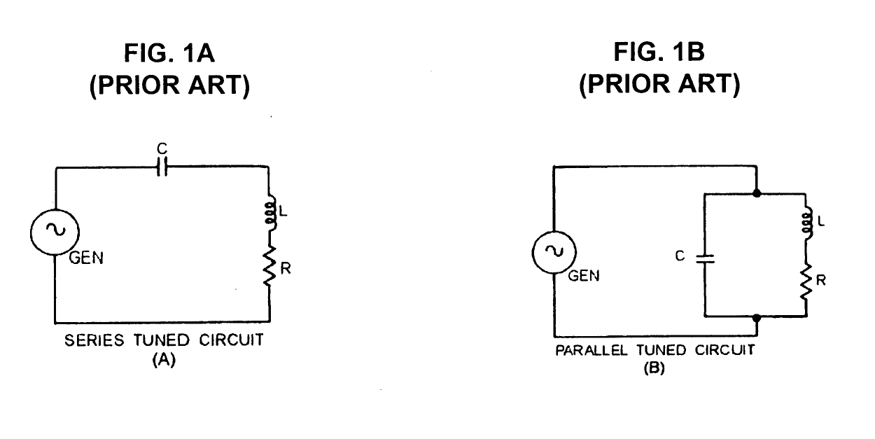

FIG. 2 is an block diagram of an exemplary chiroptical heterodyning system, which is an exemplary operating environment for methods and systems that automatically tune a resonant circuit according to an embodiment of the present invention.

FIG. 3 is an block diagram of an exemplary apparatus for automatically tuning a resonant circuit according to an embodiment of the present invention.

### DESCRIPTION OF THE EMBODIMENTS

Reference will now be made in detail to the present exemplary embodiments of the invention, examples of which are illustrated in the accompanying drawings, presentations, specifications and other technical documentation. Wherever possible, the same reference numbers will be used throughout the drawings to refer to the same or like parts.

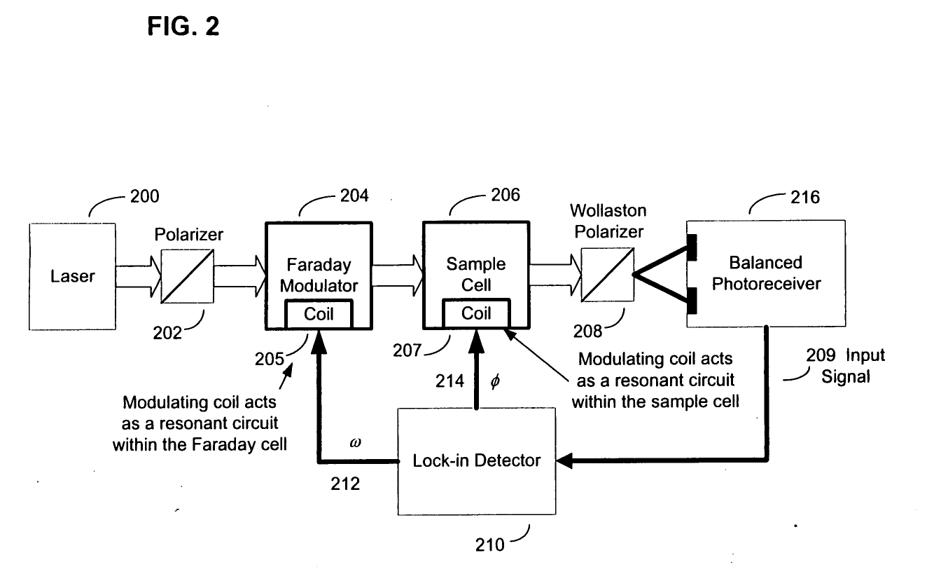

FIG. 2 illustrates an exemplary block diagram of an exemplary chiroptical heterodyning system, which is an exemplary operating environment for methods and systems that automatically tune a resonant circuit according to an embodiment of the present invention. Referring now to FIG. 2, a laser 200 generates a probe beam of light provided to a polarizer 202. Thereafter, the input linear polarization state of the probe beam may be adjusted or modulated with a Faraday modulator 204 in response to signal 212. If periodically modulated, the frequency of such modulation is designated ω. In an alternative embodiment, the Faraday modulator 204 may be another type of modulator (i.e., a device that imparts modulation onto light or a characteristic of light) or may be placed after the sample cell 206 instead of being before the sample cell 206. In general, the sample cell 206 is a device for holding the sample analyte while being exposed to light and, in some cases, further modulation. In one embodiment, the sample cell 206 holds analytes suspended in a solvent (such as water) while the probe beam is applied through the sample cell (exposing the analytes in the solvent) while additional modulation is applied to the probe beam via coil 207.

Analyzing polarizer 208 receives the resulting probe beam from the sample cell 206, but is not a focusing lens or other optical focusing element. Indeed, polarizer 208 splits up the beam into two diverging parts and, as such, has no inherent focal length. In one embodiment, the analyzing polarizer 208 is a Wollaston polarizer, which yields two inversely coupled signal beams orthogonal to each other. The beams come out of polarizer 108 at diverging angles and are intercepted by two photo-detectors placed in front of the diverging beams within a balanced photoreceiver 116. Observing these two beams using the photo-detectors in photoreceiver 116 yields a square law detector with a high common-mode rejection ratio (CMRR). In the illustrated embodiment, the driving frequencies φ and ω are synchronized with an internal reference within lock-in detector 110. The internal reference, such as a voltage controlled oscillator (not shown) or a signal synthesizer (not shown) within lock-in detector 110, is used for accurate phase determination on the sidebands.

In the illustrated embodiment, the sample cell 206 includes coil 207, which is being directly modulated in an analogous manner (Faraday rotation). Note that the Faraday modulator 204 may also use a coil operating as a resonant circuit. Thus, FIG. 2 shows coil 205 in modulator 204. Thus, the output of sample cell 206 yields modulated chiroptical signals that are dependent on the Verdet constant and natural optical activity of the sample modulated by signal 214 at a frequency of Φ.

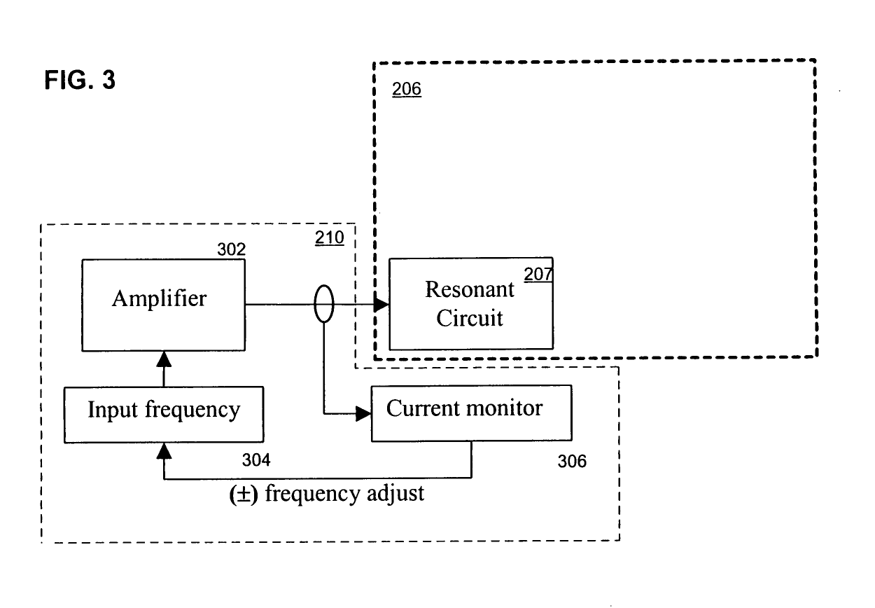

In the case of magnetic field modulation, such as that accomplished using coil 207, it is desirable to minimize system sensitivity to changing environmental factors, such as temperature in the coil (effecting resistance). As the magnetic field is only dependent on current in the modulator coil, driving the system with a constant current source allows the voltage to float and compensate for any temperature induced changes of the circuit resistance. In one embodiment, the driving circuit is implemented by a voltage controlled current source, such as a MOSFET amplifier configured in a power follower circuit as shown in FIG. 3

Referring now to FIG. 3, components making up an exemplary driving circuit are illustrated as being part of lock-in detector 210, while it is contemplated that other embodiments may have the driving circuit being separate from lock-in detector 210. In this embodiment, the illustrated driving circuit includes a current monitor 306, a frequency storage mechanism (memory storage, etc.) 304, and an amplifier 302. The output of current monitor 306, more generally referred to as a feedback circuit, can be used to adjust the frequency of the driving signal being applied (frequency stored in 304). Upon a change in frequency, amplifier 302 responds by varying the driving frequency being applied to coil 207. It is contemplated that frequency storage mechanism 304 may be implemented as interfacing logic with memory that adjusts an digital-to-analog converter (DAC) coupled to amplifier 302. As such, the driving circuit operates as a voltage controlled current source with high input impedance, a large current gain, a voltage gain of ˜1.0, and is configured for a low impedance load. Implementing the coil 207 as a series resonant circuit provides a minimum impedance load at resonance and attenuates all other frequencies other than the resonant frequency. Thus, utilization of the power follower driving circuit and a series resonant circuit as the coil 207 provides a desirably efficient method of magnetically modulating a sample that is robust against noise sources at the modulation frequency.

While this driving circuit implementation has been explained and described herein, it is contemplated that other embodiments of the present invention may utilized different amplifier configurations and benefit from the reduced power requirements of consistently driving a resonant circuit at the resonance point.

The power required to drive the series resonant circuit is a minimum at the resonant frequency, and increases rapidly for other frequencies. Therefore, matching the driving frequency from the amplifier 302 to the actual circuit is desired to enhance and maximize performance. Since inductors will have manufacturing variance (±%) but this value is basically insensitive to aging or temperature. Capacitors also have manufacturing variance (±%) but these component values can age over time and are sensitive to temperature variations. Both aging and temperature sensitivity are dependent on the materials utilized in the capacitor construction. Engineers typically take these variances into account when defining the operational characteristics of a typical application, such as a low pass filter. However, given the freedom to choose any driving frequency of the system, such as in the case of modulated signal recovery, one can operate at the true resonant point of the individual circuit at any given point during the operational lifetime.

Using the feedback loop circuit embodied as the driving circuit of FIG. 3, an automated tuning procedure may be used to avoid tolerance and drift issues in accordance with an embodiment of the present invention. In this example, the driving frequency may be automatically or manually swept over the expected range for the coil's resonance frequency, which is calculated utilizing the known component tolerances. At the resonance point, the input current to the system will be maximized at a particular frequency within the expected range for a fixed input power. In the embodiment illustrated in FIG. 3, this maximum current will be measured by current monitor 306. This frequency is stored and used to drive the resonant until another automated tuning is initiated by the user or at a regular time interval based on expected aging characteristics of the capacitor. For example, in the embodiment of FIG. 3, the frequency is stored in storage 304 and used by amplifier 302 to drive the coil 207 as the resonant circuit.

In another embodiment, storage 304 is implemented with a wavetable data structure having locations for storing one or more frequency settings. The wavetable may be pre-populated based upon an expected range of frequencies and may include other interfacing circuitry to properly interpret signals being received and used to address the appropriate storage location in the table. A digital signal processor (DSP) may be used to implement amplifier 302 by accessing the wavetable and using the content of the appropriate storage location when generating a driving signal to apply to coil 207. In some situations, the DSP may further include an amplifier or pre-amplifier to boost the level of the driving signal being applied to coil 207.

In some situations, using the signal from the sample (not necessarily chiral, e.g., water Verdet) is advantageous as it would be maximized at resonance for a given input power, leading to an enhanced sensitivity for the lock-in analysis of the Verdet signal.

In one or more embodiments of the present invention, it may be desirable to run the tuning procedure at a lower input power to the system so that the amplifier would have enough power to drive the circuit at off resonance frequencies. Also, while one could utilize the 100% of the amplifier driving at resonance to maximize the modulated field, in practice, it may be desirable to leave some capacity to allow for slight drift in the resonant frequency between tunings. The more frequently the circuit is tuned or a reduction in component susceptibility to drift (e.g., capacitor property selection) would allow this safety margin on the amplifier to be reduced. For most cases, since the limiting factor can be other factors, such as sample heating due to copper losses in the modulator coil, the net benefit is the ability to use a smaller amplifier to drive the same modulated system response.

The same tuning procedure may be utilized for parallel resonant circuits with similar benefits for compensating component variations. However, in contrast to the case shown in FIG. 3, the condition of resonance is defined as the frequency of maximum impedance. Those skilled in the art will appreciate that alternate, but equivalent, definitions of parallel resonant frequency include: the frequency at which the current is in phase with the voltage (unity power factor) and the frequency where ωL=1/ωC (e.g., the resonant frequency of the equivalent series RLC circuit where resistances are small). The feedback criteria to determine the resonant frequency would look for a minimum in the supplied current to the circuit shown in FIG. 3. Alternatively, the voltage could be measured at the input terminals and this value would be at maximum at resonance. Such a tuned parallel resonant circuit, also called a tank circuit, would be useful in applications involving modulation of high electric fields, such as studies of the Kerr and Pockels effects. The parallel circuit also has the property attenuating frequencies other than the resonant frequency, which is beneficial when the system is modulated by parallel resonant circuit frequency for response analysis using a lock-in or other signal recovery techniques.

In another alternative embodiment, a further enhancement may be possible to fine tune the frequency. In such a situation, the driving circuit may set the driving frequency independent of the DSP used for lock-in analysis and then use the Verdet measurement from the lock-in analysis to further fine tune the frequency driving the resonant circuit. While some embodiments may not need this level of frequency adjustment (e.g., the benefits of being 1 Hz off true resonance may be negligible compared with being 10 or 100 Hz off), others may benefit from this level of precision and sensitivity depending upon the how “sharp” the frequency profile is for the circuit's resonance point. In experimental embodiments of the present invention, it has been observed that the driving circuit (also called the system controller/current monitor) can tune to a 1 Hz resolution, and with further fine tuning have a resolution down to 0.2 Hz when the fundamental frequency ranges of interest are 1-5 kHz for the analytical measurement system setup.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for automated tuning of a resonant circuit when detecting a chiral property of a sample, comprising:
populating a data structure with a plurality of frequencies, the plurality of frequencies being pre-determined within an expected range of frequencies for the resonant circuit;
generating a driving signal using one of the plurality of frequencies in the data structure;
applying the driving signal to the resonant circuit while detecting a chiral property of the sample based at least in part upon the one of the plurality of frequencies in the data structure;
measuring a feedback signal associated with the driving signal; and
adjusting the driving signal to use another one of the plurality of frequencies in the data structure in response to the feedback signal.

2. A method for automated tuning of a resonant circuit when detecting a chiral property of a sample, comprising:
applying a driving signal to the resonant circuit, the driving signal having a driving frequency within a range of frequencies;
monitoring a resonance parameter of the driving signal as part of a feedback loop to produce a feedback signal; and
adjusting the frequency of the driving signal according to the monitored resonance parameter, the adjusted frequency of the driving signal modulating a probe beam of light used for detecting the chiral property of the sample.

3. The method of claim 2, wherein the resonance parameter is a current.

4. The method of claim 2, wherein the adjusting step is performed to optimize the resonance parameter when the resonance parameter is power.

5. The method of claim 2, wherein the adjusting step is performed to optimize the resonance parameter when the resonance parameter is power.

6. The method of claim 2, wherein the applying step further comprises applying the driving signal at a reduced power level to enable driving the resonant circuit at off-resonant frequencies within the range of frequencies.

7. The method of claim 2, wherein the adjusting step further comprises adjusting the frequency of the driving signal to create a resonant condition with regard to the resonant circuit.

8. An apparatus for automated tuning of a resonant circuit when detecting a chiral property of a sample, comprising:
a sample cell for holding the sample, the sample cell being modulated by the resonant circuit;
a signal source coupled to the resonant circuit, the signal source being capable of generating a driving signal at one of a plurality of frequencies to modulate the resonant circuit, the plurality of frequencies being within a range of expected resonant frequencies for the resonant circuit; and
a feedback loop circuit coupled to the signal source and operative to adjust the one of the plurality of frequencies of the driving signal to another of the plurality of frequencies in response to a feedback signal, the feedback signal being associated with a measured parameter of the driving signal.

9. The apparatus of claim 8, wherein the sample cell is magnetically influenced by a coil as the resonant circuit.

10. The apparatus of claim 9, wherein the signal source is operative to sweep through the plurality of frequencies.

11. The apparatus of claim 10, wherein the signal source further comprises a digital signal processor (DSP) coupled to a memory storage, the contents of the memory storage storing values indicative of the plurality of frequencies.

12. The apparatus of claim 8, wherein the feedback loop circuit is operative to adjust the one of the plurality of frequencies to create a resonant condition with regard to the resonant circuit.

13. The apparatus of claim 11, wherein the feedback loop is a current monitor that measures the current of the driving signal as the measured parameter of the driving signal, the current monitor being in communication with the DSP and being operative to indicate a frequency adjustment relative to the current one of the plurality of frequencies.

14. An apparatus for automated tuning of a resonant circuit when detecting a chiral property of a sample, comprising:
a light source for generating a probe beam of light;
a sample cell for holding the sample and a solvent for the sample as the probe beam of light is exposed to the sample, the probe beam of light being modulated by the resonant circuit;
a modulation source coupled to the resonant circuit, the modulation source applying a driving signal at one of a plurality of frequencies to the resonant circuit, the plurality of frequencies being within a range of expected resonant frequencies for the resonant circuit;
a monitoring circuit for monitoring a measured parameter of the driving signal as the driving signal is applied to the resonant circuit; and
a feedback circuit coupled to the modulation source and operative to adjust the one of the plurality of frequencies of the driving signal to another of the plurality of frequencies in response to a feedback signal, the feedback signal being associated with the measured parameter of the driving signal.
